(19) United States
(12) Patent Application Publication
(10) Pub. No.: US 2014/0378104 A1
(43) Pub. Date: Dec. 25, 2014

(54) METHOD AND DEVICE FOR PROCESSING SHORT MESSAGES

(71) Applicant: Tencent Technology (Shenzhen) Company Limited, Shenzhen (CN)

(72) Inventor: Jiashun SONG, Shenzhen (CN)

(73) Assignee: Tencent Technology (Shenzhen) Company Limited, Shenzhen (CN)

(21) Appl. No.: 14/266,713

(22) Filed: Apr. 30, 2014

Related U.S. Application Data
(63) Continuation of application No. PCT/CN2014/072147, filed on Feb. 17, 2014.

(30) Foreign Application Priority Data
Jun. 20, 2013 (CN) 201310246394.4

(51) Int. Cl. H04W 4/14

(52) U.S. Cl. CPC H04W 4/14
USPC 455/412.2; 455/412.1

(57) ABSTRACT

A method and device of processing short messages are disclosed. The method includes: at a device having one or more processors and memory: receiving a message delivery request for a short message from a sender of the short message; processing the short message in accordance with a plurality of filtering rules associated an intended recipient of the short message; in response to a determination that the short message triggers at least one of the plurality of filtering rules, intercepting delivery of the short message from the intended recipient of the short message; and proactively re-evaluating the short message for re-delivery to the intended recipient in accordance with one or more message revival rules and one or more events occurring after the short message has been intercepted from delivery to the intended recipient.

### RELATED APPLICATIONS

This application is a continuation application of PCT Patent Application No. PCT/CN2014/072147, entitled “Method and Device for Processing Short Messages” filed Feb. 17, 2014, which claims priority to Chinese Patent Application Serial No. 201310246394.4, entitled “Method, Apparatus, and Device for Processing Short Messages”, filed Jun. 20, 2013, the entirety of both of which is incorporated herein by reference.

### FIELD OF THE INVENTION

The present invention relates to the field of mobile terminal device technology, and in particular, relates to a method, apparatus and terminal device for short message processing.

### BACKGROUND OF THE INVENTION

With the development of mobile terminal device technology, mobile terminal devices have become an important way for people to obtain information and interact with one another. People get a variety of information through their mobile terminal devices, such as news, entertainment and sport information. However, end-users also receive spam messages pushed by various kinds of numbers, for example, the numbers belonging to finance, study aid, and other intermediary agents. These unsolicited messages can lead to at least several spam messages and even more than ten messages delivered to a user in one day. Since users often do not need the information contained in these spam messages, the users have to manually delete these spam messages one by one. Also, the spam messages take up storage space on the terminal devices, and may even cost the user data usage quota when the messages are delivered to the users. In addition, the constant alerts generated by these unsolicited spam messages are also an annoyance to the users. How to effectively intercept these spam messages has become a very important research topic.

Some conventional technology can intercept spam messages by way of setting a keyword database, e.g., a blacklist and a white list for spam and legitimate contact numbers. However, after intercepted by the above mentioned method, the short messages are permanently lost, and cannot be recovered by the user. Furthermore other short messages subsequently sent by a blacklisted number will also be intercepted. However, in practice, the possible situation is, the short message sent by a number may be a spam message for the user in one period of time, but may become a desirable message for another period of time. Presently, if a short message has been intercepted, the user can neither obtain the intercepted message immediately, nor recover it later. In summary, the conventional technology can't recover the intercepted short messages according to the practical communication situation after the messages have been intercepted, making the users miss certain important short message information.

### SUMMARY

In some embodiments, a method of processing short messages includes: at a device having one or more processors and memory: receiving a message delivery request for a short message from a sender of the short message; processing the short message in accordance with a plurality of filtering rules associated an intended recipient of the short message; in response to a determination that the short message triggers at least one of the plurality of filtering rules, intercepting delivery of the short message from the intended recipient of the short message; and proactively re-evaluating the short message for re-delivery to the intended recipient in accordance with one or more message revival rules and one or more events occurring after the short message has been intercepted from delivery to the intended recipient. The method further includes: proactively determining whether one or more message revival events related to the short message has occurred; and in accordance with a determination that at least one message revival event has occurred, delivering the short message to the intended recipient.

In another aspect, a device comprises one or more processors, memory, and one or more program modules stored in the memory and configured for execution by the one or more processors. The one or more program modules include instructions for performing the method described above. In another aspect, a non-transitory computer readable storage medium having stored thereon instructions, which, when executed by a device, cause the device to perform the method described above.

### BRIEF DESCRIPTION OF THE DRAWINGS

The aforementioned features and advantages of the invention as well as additional features and advantages thereof will be more clearly understood hereinafter as a result of a detailed description of preferred embodiments when taken in conjunction with the drawings.

FIG. 1 is a flowchart of a short message processing method in accordance with some embodiments;

FIG. 2 is a flowchart of a short message processing method in accordance with some embodiments.

FIG. 3 is a structural schematic diagram of a short message processing apparatus in accordance with some embodiments.

FIG. 4 is a block diagram of a device for processing short messages in accordance with some embodiments.

Like reference numerals refer to corresponding parts throughout the several views of the drawings.

### DESCRIPTION OF EMBODIMENTS

In order to make a clearer understanding of purpose, technical scheme and advantages of the present invention, the following will give further detailed description with reference to attached drawings and embodiments. It should be understood that the specific embodiment described herein is merely used to illustrate the present invention, rather than to limit the present invention.

As described in the background section, short messages are an important way of instant communication for users of mobile terminal devices, such as mobile telephones, tablets, smart phones, etc. Short messages are instant text messages that are delivered according to the protocols of Short Message Services (SMS) or other similar instant message protocols. The delivery of the short messages can be accomplished through the telephone network (e.g., the PSTN network, the GSM network, TDMA networks, etc.). In some embodiments, short messages referred to herein also include short messages containing other multimedia content, such as icons, videos, images, sounds, etc. In some embodiments, short messages also include instant messages that are delivered on a social networking platform, such as the instant short messages sent from one user to another user associated with respective user accounts on the WeChat™ platform. As described herein, the short messages are different from email messages and do not require a mail server or a mail application on the terminal device to be delivered and presented to the user. In general, a short message has a sender and an intended recipient, identified by their respective identifiers such as their respective telephone numbers.

In some embodiments, when a short message is received by a message server, the message server determines whether the short message should be intercepted in accordance with a plurality of message interception rules (e.g., spam filtering rules). If the short message satisfies one or more of the message interception rules, the message server intercepts message and does not deliver the short message to the intended recipient of the short message. Conventionally, the interception of the short message means the intended recipient will have no knowledge of the short message, and the short message is permanently lost. As described herein, the message server proactively revisits the decision to intercept the message at a later time, e.g., either periodically, or after a short period of time, or upon triggering of one or more predetermined message revival events, to determine whether the previously intercepted short message is likely to be relevant to the intended recipient. If the message server determines that the short message satisfies one or more preset message revival rules, the message server delivers the previously intercepted short message to the intended recipient.

In some embodiments, in addition to delivering the intercepted short message, the message server also searches a message repository to determine whether other earlier short messages sent by the corresponding number of the redelivered short message to the same intended recipient had been previously intercepted. If the message server discovers that there are other earlier short messages sent by the number corresponding to the mentioned short message to the same intended recipient had been intercepted previously, the message server optionally recover these other intercepted short messages, and deliver them to the intended recipient.

It should be noted that the message server proactively revisit the decision to intercept the previously intercepted short messages without the user requesting the message server to do so. In other words, the user does not have to visit a SPAM message folder proactively to request particular messages to be recovered. Instead, the message server intelligently recovers certain previously intercepted messages based on well designed message revival rules and relevant events that have occurred near or after the time that the message has been intercepted. In some embodiments, the message server does not perform the above actions, instead, these actions are performed locally by the terminal device, and the interception of the short message refers to the withholding of the message from displaying to the user and/or sending an alert regarding the message to the user.

In some embodiments, after a terminal device receives a short message, the terminal device determines whether this short message is a spam message or not according to one or more predetermined interception or filtering rules. If the message is a spam message, the terminal device intercepts the mentioned short message and does not present it to the user of the terminal device. If the mentioned spam message is not a spam message, the terminal device releases the mentioned short message and displays it on the terminal device. If however, the short message processed by interception or filtering rules may be intercepted by mistake due to design imperfection of the rules. Therefore, after processed by the interception or filtering rule, the terminal device optionally performs a reconsideration process to revisit the decision to intercept the short message after a short while (e.g., after a predetermined time window, or after occurrence of a triggering event) of the interception of the mentioned short message. The reconsideration process should be conducted to ensure that the conducted interception or release for the mentioned short message is reasonable. If the interception of the short message does not appear to be reasonable in light of new knowledge available to the terminal device, the mentioned intercepted short message can be timely recovered by the terminal device and released to the user. In some embodiment, the terminal device does not perform the interception and reconsideration processes, but rather relies on a message server to perform the interception and reconsideration processes, and acts according to the decisions of the message server.

In some embodiments, the mentioned interception or filtering rules can be utilize as following:

(1) Determine whether the received short message belongs to a category of special messages (e.g., theft and fraud protection short messages, auto-correction short messages, usage deduction scanning short messages and so on). These special messages are messages from known spamming numbers. If “yes”, intercept the short message and hand it over to the other module to process; and if “no”, carry out step (2);

(2) Determine whether the received short message belongs to the recipient's private contacts (e.g., contacts in the user's private contact list). If “yes”, intercept and hand it over to the privacy mailbox to process; and if “no”, carry out (3);

(3) Determine whether the received short message belongs to a white list (e.g., a user-specified list of acceptable numbers), if “yes”, release the message to the user; if “no”, carry out (4);

(4) Determine whether the received short message belongs to a black list (e.g., a user-specified list of blocked numbers), if “yes”, intercept the message; if “no”, carry out (5);

(5) Determine whether the received short message belongs to a list of system contacts, if “yes”, release the message to the user; if “no”, carry out (6);

(6) Determine whether the received short message belongs to the recent actively dialed number (e.g., 50 phone numbers with unknown contacts) or not, if “yes”, release the message to the user; if “no”, carry out (7);

(7) Determine whether the received short message triggers a keyword intercepting rule (e.g., keyword such as “xxx”, or other restricted words), if “yes”, intercept the message; if “no”, carry out (8); and

(8) Determine whether the received short message triggers other intelligent intercepting rules, if “yes”, intercept the message; and if “no”, release the message to the user.

In some embodiments, after the routine processing of short messages using the routine interception and filtering rules, the re-evaluation of the intercepted short messages can be performed to determine whether the intercepted short message should be released to the intended recipient.

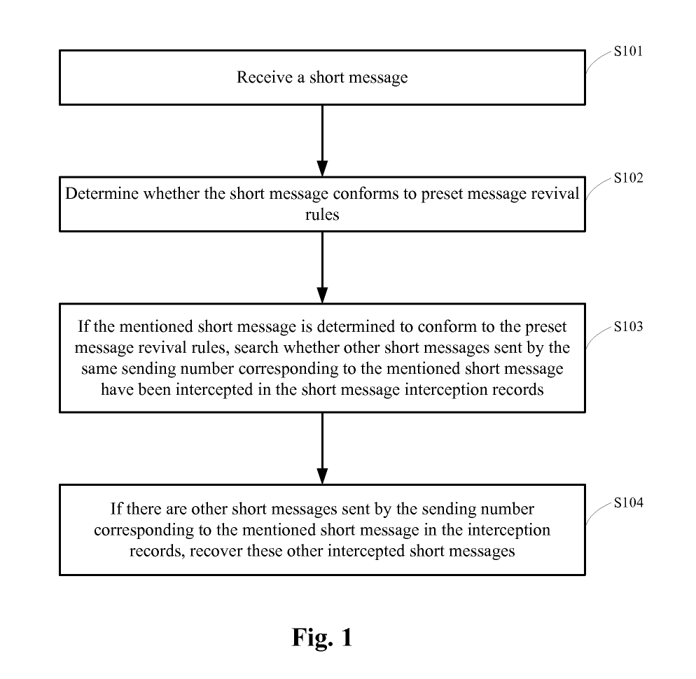

FIG. 1 is a flowchart diagram an exemplary message processing method in accordance with some embodiments. In some embodiments, the method is performed on the terminal device. In some embodiments, the method is performed by a message server. In some embodiments, the message server and the terminal device performs different steps of the method.

In S101, the device receives a short message.

In this embodiment, the mentioned received short message can be the original received short message by a terminal device and can also be the short message processed by the aforementioned interception rules.

In S102, the device determines whether the short message conforms to preset message revival rules or not.

In this embodiment, the mentioned preset message revival rules can be set according to the communication situations between other numbers with the current terminal device, e.g., call frequency, conversation time, content of short messages, and so on. The following includes several kinds of specific message revival rules.

Optionally, S102 can be implemented by the way of S102a: if a conversation time (e.g., a duration of a telephone call, an voice-over-IP call, or a live chat session) between the sending number of the short message and the number of the current terminal (e.g., the recipient number of the short message) is above a preset time threshold, it is determined that the mentioned short message conforms to the preset message revival rule.

Further, in some embodiments of S102a, S102 can be implemented by the way of S102b: when the sending number of the mentioned short message is in the unfamiliar call list (e.g., a list of calls made with unknown contacts—i.e., numbers not saved in the user's contact list), and the conversation time between the number corresponding to the sender of the mentioned short message and the number corresponding to the current terminal is above a preset time threshold, it is determined that the mentioned short message conforms to the preset message revival rule. In some embodiments, the mentioned unfamiliar call list stores the N most recent dial-in communication numbers that have communicated with the current terminal. Further, the device determines whether to revive the short message based on the call status of the receiving terminal device. If the conversation time between the number of mentioned terminal device and the sending number of the short message is above the preset time threshold, the short message sent by this sending number could be useful information for the user of the receiving terminal device, and this short message should be revived and released to the user. In some embodiments, S103 is carried out as well. Consequently, short messages that are incorrectly intercepted can be timely recovered.

Optionally, S102 can be implemented by the way of S102c: if the sending number corresponding to the mentioned short message has sent another short message having the same content as the intercepted message to the receiving terminal device, it is determined that the mentioned intercepted short message conforms to the preset message revival rules.

In some embodiments, whether the sending number corresponding to the mentioned short message has sent another short message having the same content to the current terminal or not can be determined by matching the subsequently received short message to the intercepted short message. In the process of matching respective content of different short messages, in some embodiments, only the first N words are compared, among which, N is an integer, e.g., 15.

Optionally, S102 can be carried out by the way of S102d: if before receiving the mentioned short message, the mentioned receiving terminal number had actively initiated communication (e.g., sent a short message or initiated a telephone call) to the sending number corresponding to the mentioned short message, it is determined that the mentioned short message conforms to the preset message revival rules. That is, if before receiving this short message from the sender, if the receiving terminal number has proactively communicated with the sending number of the mentioned short message, it indicates that this sending number could be a useful number to the user, and this short message should not be intercepted, the short message should be revived and released to the user. In some embodiments, S103 is also carried out.

In S103, if the mentioned short message is determined to conform to the preset message revival rules, the device searches whether other short messages sent by the same sending number corresponding to the mentioned short message have been intercepted in the short message interception records.

In some embodiments, the mentioned interception records stores previously intercepted short messages and relevant information related to the intercepted message, e.g., time of deletion and location. The mentioned interception records can be stored in the local terminal device and/or stored at the message server. By storing the messages at the server, storage space of the terminal device can be conserved.

In S104, if there are other short messages sent by the sending number corresponding to the mentioned short message in the interception records, recover these other intercepted short messages.

In some embodiments, in order to ensure the effectiveness of recovery, during the process of recovery, only the received short messages sent by the sending number corresponding to the mentioned short message within a preset time frame are recovered at this time. For example, in some embodiments, the device only searches whether there are other short messages sent by the sending number of the mentioned short message in the short message interception records of the most recent three days. This not only ensures the timeliness of the short message recovery, but also improves the efficiency of the search.

Optionally, after S103, the mentioned method can also include: receive and display the other intercepted short messages sent by the sending number corresponding to the mentioned short message, thus ensuring that the other short messages corresponding to this number will no longer be intercepted. In some embodiments, the number is added to a white list, and all future short messages from this number will no longer be intercepted.

It is worth noting that the mentioned receiving number in the aforementioned embodiments is a mobile phone number, and can also be the number of other terminal devices that can send and receive short messages.

In order to facilitate understanding, the following are a few exemplary usage scenarios in accordance with some embodiments:

Scenario I: Suppose that, soon after terminal A has dialed the phone number of terminal B and established a telephone conversion with terminal B, terminal A sends a short message to terminal B, if terminal B hasn't not had time to put the number of terminal A in the system contact list, the short message received by the terminal device of terminal A will be likely to be incorrectly intercepted for triggering an existing interception or filtering rule implemented for terminal B, and be processed as a spam message. At this moment, through processing of S102a, if the conversation time between the sending number of the mentioned short message and the number of the terminal B is above a preset time threshold (e.g., 30 seconds), then it is determined that this short message conforms to the preset message revival rule, and the short message sent by terminal A will be released to terminal B and all other short messages sent by terminal A to terminal B will also be recovered and released to terminal B.

Scenario II: Suppose that terminal A has sent a short message to terminal B, and this message has been intercepted for triggering an interception or filtering rule. The user of terminal A discovers that the user of terminal B has made no reply to the short message after a period of time, and re-sends this short message again. At this time, according to the processing of S102c, if the sending number of the mentioned short message has sent another short message having the same content to terminal B, it is determined that the mentioned short message conforms to the preset message revival rules. In other words, if terminal A has sent more than one short messages having the same content to terminal B, then the short message can be released to terminal B, and be displayed on the terminal device of terminal B.

Scenario III: Suppose that terminal A has sent a short message to terminal B, and that terminal A has not put terminal B in its system contact list, if terminal B replies to the short message, the replied message will be likely to be incorrectly intercepted for triggering the preset interception or filtering rules. At this time, according to the processing of S102d, since before receiving the short message from terminal B, the receiving terminal number has actively communicated with the sending number of the short message, then it is determined that the short message (i.e., the reply message from terminal B to terminal A) conforms to the preset message revival rule. In some embodiments, the active communication can be sending a short message, making a telephone call, or making a voice-over-IP call, and so on. If terminal A actively contacted with terminal B, and terminal B replied with a short message, the short message can be released to terminal A, and displayed on a terminal device of terminal A.

In some embodiments, if a terminal device receives a short message and the mentioned short message conforms to a preset message revival rule, the device searches whether other short messages sent by the sending number corresponding to the mentioned short message have been intercepted or not in the short message interception records. If there are other short messages sent by the sending number corresponding to the mentioned short message having been intercepted, the intercepted other short messages are recovered. When a short message is intercepted, and the mentioned short message conforms to a preset revival rule, the short message can be timely recovered, thus decreasing the rate of wrong interception, and reducing the likelihood that the users may miss some important short messages.

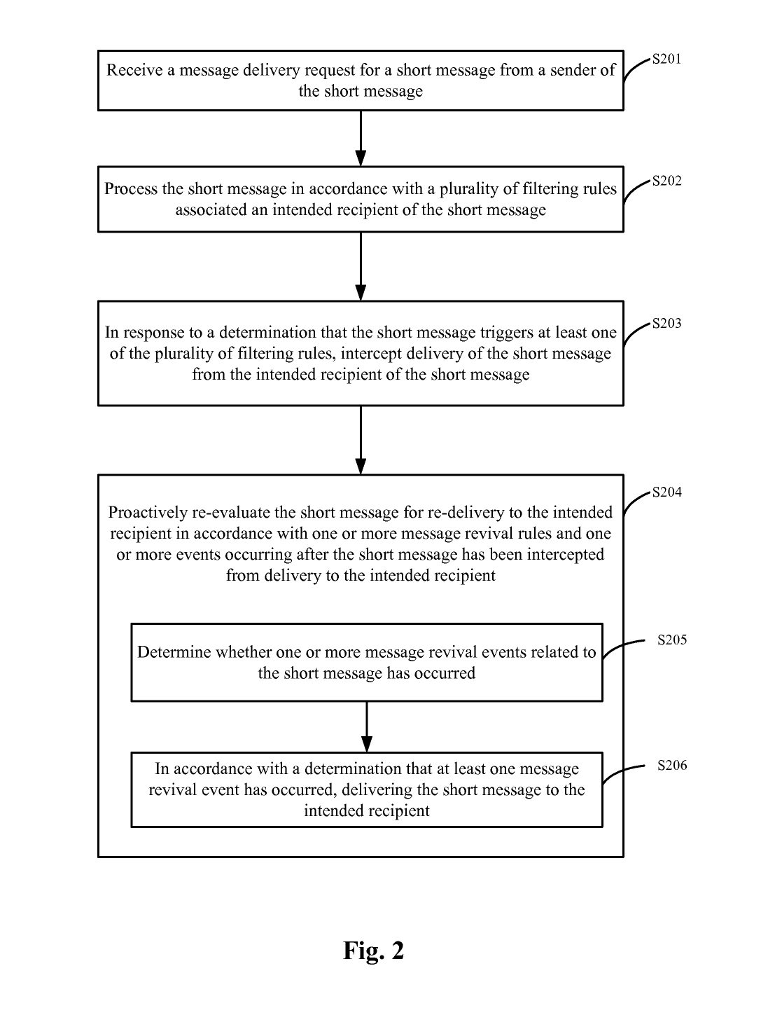

FIG. 2 is a flow chart of a method of short message processing in accordance with some embodiments. The method may be performed by a receiving terminal device or a message server in various embodiments.

At a device having one or more processors and memory:

S201: receive a message delivery request for a short message from a sender of the short message.

S202: process the short message in accordance with a plurality of filtering rules associated an intended recipient of the short message.

S203: in response to a determination that the short message triggers at least one of the plurality of filtering rules, intercept delivery of the short message from the intended recipient of the short message. In some embodiments, intercepting delivery of a short message includes downloading the message to the local terminal device, but does not release any notification of the short message to the user. In some embodiments, intercepting delivery of the short message includes refusing to download the short message to the local terminal device. In some embodiments, intercepting delivery of a short message includes storing the short message on the message server and not sending the short message to the local receiving terminal device.

S204: proactively re-evaluate the short message for re-delivery to the intended recipient in accordance with one or more message revival rules and one or more events occurring after the short message has been intercepted from delivery to the intended recipient. The proactive re-evaluation is performed by the device without the user's request. Thus, this is distinct from the scenario in which spam messages are stored in a local folder on the terminal device, and the user can review the sending number and/or a summary of the spam messages and manually select the ones that he or she wishes to recover. This is also distinct from a filter exception rules pre-established by the user, which is run as part of the intercepting and filtering process.

In some embodiments, the proactive re-evaluating includes:

S205: determine whether one or more message revival events related to the short message has occurred; and

S206: in accordance with a determination that at least one message revival event has occurred, delivering the short message to the intended recipient.

In some embodiments, the plurality of filtering rules associated with the intended recipient of the short message includes one or more SPAM filters.

In some embodiments, proactively re-evaluating the short message for re-delivery to the intended recipient further includes: after a predetermined period of time has elapsed since the interception of the short message, proactively determining whether one or more message revival events related to the short message has occurred during the predetermined period of time, wherein the one or more message revival events satisfy the one or more message revival rules; and in accordance with a determination that at least one message revival event has occurred, delivering the short message to the intended recipient.

For example, after a short message has been intercepted, the message is stored and not released to the receiving terminal device or displayed to the user. After a predetermined period of time (e.g., 3 hours or 1 day), the device (e.g., the message server or the terminal device, depending on the specific embodiments) proactively evaluate the short message again in light of new events and information that may have occurred during the period of time. If the receiving terminal has proactively contacted the sending terminal during this time, or added the sending terminal to its contact list, the device will determine that the short message meets the requirement of revival, and recovers the short message and releases it to the receiving terminal.

In some embodiments, proactively re-evaluating the short message for re-delivery to the intended recipient further includes: detecting a user request for creating a new contact from the intended recipient of the short message; in response to detecting the user request for creating the new contact, proactively determining whether the sender of the short message is the new contact being created by the intended recipient; and in accordance with a determination that the sender of the short message is the new contact, delivering the short message to the intended recipient.

In some embodiments, proactively re-evaluating the short message for re-delivery to the intended recipient further includes: detecting a communication event originating from the intended recipient to the sender of the short message; in response to detecting the communication event, delivering the short message to the intended recipient.

In some embodiments, proactively re-evaluating the short message for re-delivery to the intended recipient further includes: detecting a live communication event originating from the sender to the intended recipient of the short message, the live communication event occurring after the interception of the short message; in response to detecting the live communication event, proactively determining whether the live communication event satisfy at least one of the one or more message revival rules.

In some embodiments, proactively determining whether the live communication event satisfy at least one of the one or more message revival rules further includes: determining whether a duration of the live communication event exceeds a predetermined threshold duration. In some embodiments, the method further includes: in accordance with a determination that the duration of the live communication event exceeds the predetermined threshold duration, delivering the short message to the intended recipient of the short message.

In some embodiments, the live communication event is a telephone call from the sender to the intended recipient of the short message, and delivering the short message to the intended recipient of the short message further includes: receiving a call termination signal from at least one of the sender and the intended recipient of the short message; presenting a prompt to at least the intended recipient regarding the short message before terminating the call. For example, after a short message from terminal A to terminal B has been intercepted, if a live telephone call between terminal A and terminal B is detected and the duration of the live telephone call has lasted more than 20 seconds, it is determined that the short message meets the revival rule, and the short message should be recovered and released to terminal B. In some embodiments, instead of directly releasing the short message to terminal B, a prompt (e.g., “you have a short message from terminal A that was previously intercepted, would you like to see it?”). In some embodiments, in order to not disturb the flow of the call, the prompt is not presented to the user until a call termination signal is received from either terminal A or terminal B. Once the call termination signal is received, the prompt is presented to the user of terminal B, while the call session is kept alive. If the user of the terminal B decides to view the short message, the short message is released to terminal B and displayed to the user of terminal B. The user of terminal B can then choose to talk to the user of terminal A regarding the short message if needed.

In some embodiments, presenting the prompt to at least the intended recipient regarding the short message before terminating the call further includes: delivering an automated voice alert to at least the intended recipient indicating that there is at least one short message from the sender to the intended recipient that had been intercepted prior to the live communication event. In some embodiments, the method further includes: receiving a user instruction to present the short message after delivering the automated voice alert to at least the intended recipient; and in response to the user instruction, presenting the short message to the intended recipient before terminating the live communication event. In some embodiments, the user instruction is received from the sender before the termination of the telephone call. For example, in some embodiments, the sender of the intercepted message is notified during the live telephone call that his/her previous short message has been intercepted and not released to the recipient. The sender of the intercepted message is provided with an opportunity during the live call to release the short message or to permanently delete the intercepted message. If the sender chooses to release the short message, the short message is recovered and released to the recipient immediately, otherwise, the short message is deleted, and the intended recipient would have no knowledge of the short message. In some embodiments, the user instruction is received from the intended recipient before the termination of the telephone call. In some embodiments, the method further includes: receiving a second call termination request after presenting the prompt regarding the short message; and terminating the telephone call in response to receiving the second call termination request. For example, after the intended recipient has been notified of the existence of the intercepted short message, the intended recipient can choose to view the message while the call is still connected, or provide an input to terminate the call. The intended recipient can then view the short message after the call is terminated, or choose to ignore it, or delete it permanently. In some embodiments, the telephone call referred to above may be accomplished through a live voice-over-IP call between two mobile computing devices, or between a computing device and a mobile telephone.

In some embodiments, the live communication event is a live chat session between the sender to the intended recipient of the short message, and wherein delivering the short message to the intended recipient of the short message further includes: receiving a call termination signal from at least one of the sender and the intended recipient of the short message; and presenting a prompt to at least the intended recipient regarding the short message before terminating the call.

In some embodiments, proactively determining whether the live communication event satisfy at least one of the one or more message revival rules further includes: determining whether the live communication event includes more than a threshold number (e.g., 2) of discrete interactions (e.g., separate messages back and forth) between the sender and the intended recipient of the short message. In some embodiments, the method further includes: in accordance with a determination that the live communication event includes more than the threshold number of discrete interactions between the sender and the intended recipient of the short message, delivering the short message to the intended recipient of the short message.

In some embodiments, the live communication event is a live chat session between the sender and the intended recipient of the short message, and delivering the short message to the intended recipient of the short message further includes: presenting a prompt to at least the intended recipient regarding the short message during the live chat session.

In some embodiments, the method further includes: presenting the short message to the intended recipient of during the live chat session. In some embodiments, the method further includes: presenting the short message to the sender of the short message during the live chat session.

In some embodiments, proactively re-evaluating the short message for re-delivery to the intended recipient further includes: receiving a second message delivery request for a second short message from the sender of the short message to the intended recipient of the intercepted short message; and in response to receiving the second message delivery request, determining whether the second short message refers to the intercepted short message. In some embodiments, in response to a determination that the second short message refers to the intercepted short message, delivering both the intercepted short message and the second short message to the intended recipient of the intercepted short message.

In some embodiments, proactively re-evaluating the short message for re-delivery to the intended recipient further includes: receiving a second message delivery request for a second short message from the sender of the short message to the intended recipient of the intercepted short message; and in response to receiving the second message delivery request, determining whether the second short message is substantially identical to the intercepted short message. In some embodiments, the method further includes: in response to a determination that the second short message is substantially identical to the intercepted short message, delivering one of the intercepted short message and the second short message to the intended recipient of the intercepted short message.

In some embodiments, the proactively re-evaluation of the short message for re-delivery to the intended recipient is performed within a predetermined time window since the interception of the short message.

In some embodiments, in accordance with a determination that the one or more events satisfy at least one of the message revival rules, the method further includes: delivering the short message to the intended recipient of the short message; scanning for additional previously intercepted short messages from the sender to the intended recipient in a message repository; and in response to discovering at least one additional previously intercepted short message from the sender to the intended recipient in the message repository, delivering at least a prompt regarding the additional previously intercepted short message to the intended recipient.

In some embodiments, the method further includes delivering the at least one additional previously intercepted short message to the intended recipient. In some embodiments, delivering the at least one additional previously intercepted short message to the intended recipient further includes: delivering the at least one additional previously intercepted short message to the intended recipient in an e-mail message to the intended recipient of the short message.

In some embodiments, proactively re-evaluating the short message for re-delivery to the intended recipient further includes: periodically scanning a call log of the intended recipient of the short message; and in response to discovering a telephone call between the sender and the intended recipient of the short message within a predetermined time window of the interception of the short message, proactively determining whether the duration of the telephone call exceeds a predetermined threshold duration. In some embodiments, the method further includes: in accordance with a determination that the duration of the telephone call exceeds the predetermined threshold duration, delivering the short message to the intended recipient of the short message. In some embodiments, periodically scanning the call log of the intended recipient of the short message further includes: scanning N most recent calls with no contact names to determine if at least one of the N calls is between the sender and the intended recipient of the short message, where N is a predetermined natural number; and the method further includes: in response to discovering at least one call between the sender and the intended recipient of the short message among the N most recent calls with no contact names, delivering the short message to the intended recipient.

The above embodiments are described for illustrative purposes only, and various features described in the present disclosure may be combined in various embodiments.

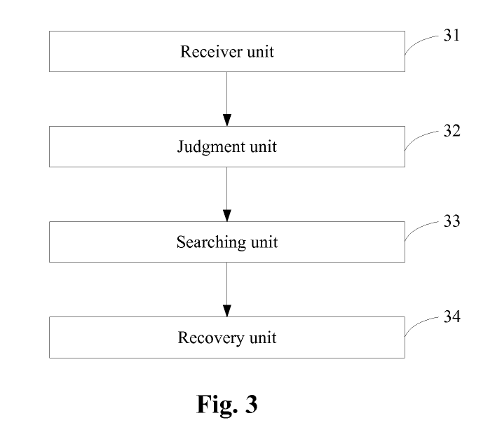

FIG. 3 is a structural diagram of a short message processing apparatus provided in accordance with some embodiments. This apparatus can be a software unit, hardware unit, or combination unit of software and hardware internally installed in a terminal device or a message server to perform the short message processing methods described above.

In some embodiments, the mentioned apparatus include: receiver unit 31, judgment unit 32, searching unit 33 and recovery unit 34.

Receiver unit 31 is configured to receive a short message;

Judgment unit 32 is configured to determine whether the received short message conforms to preset message revival rules;

Searching unit 33, is configure to, if the mentioned short message conforms to the preset message revival rule, search whether other short messages sent by the sending number corresponding to the mentioned short message have been intercepted in a short message interception records;

Recovery unit 34, is configured to, if there are other short messages sent by the sending number corresponding to the mentioned short message being intercepted, recover the other intercepted short messages.

Optionally, the mentioned receiver unit 31 is also configured to receive and display the other short messages sent by the sending number corresponding to the mentioned short message.

Optionally, if the conversation time between the sending number corresponding to the mentioned short message and current receiving terminal is above a preset time threshold, the mentioned judgment unit 32 is configured to determine that the mentioned short message conforms to the preset revival rules.

Optionally, when the sending number corresponding to the mentioned short message is in a unfamiliar call list, and the conversation time between the sending number corresponding to the mentioned short message and the current receiving terminal is above the preset time threshold, the mentioned judgment unit 32 is configured to determined that the mentioned short message conforms to the preset revival rule, and the mentioned unfamiliar call list stores the most recent dial-in communication numbers that communicated with the current receiving terminal.

Optionally, if the sending number corresponding to the mentioned short message has sent another short message having the same content to the present receiving terminal, the mentioned judgment unit 32 is configured to determine that the mentioned short message conforms to the preset revival rules.

Optionally, if before receiving the mentioned short message, the mentioned receiving terminal number actively communicates with the sending number corresponding to the mentioned short message, the mentioned judgment unit 32 is configured to determine that the mentioned short message conforms to the preset message revival rule.

Other functions of the short message processing apparatus are provided with respect to FIGS. 1 and 2.

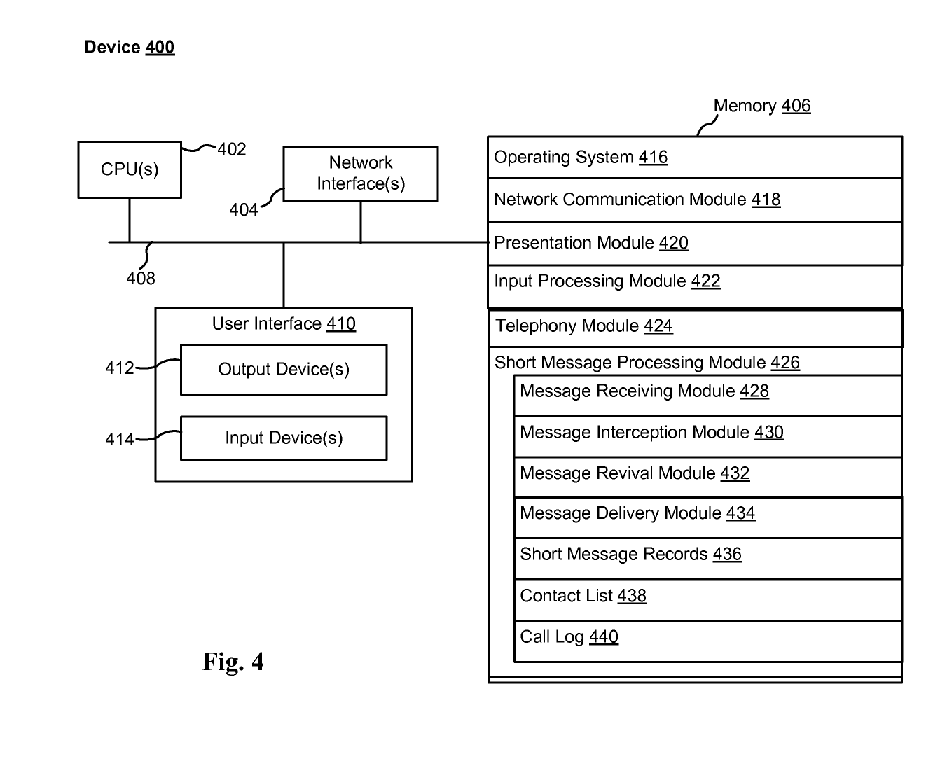

FIG. 4 is a block diagram of a device 400 for performing the short message processing methods described above in accordance with some embodiments. In some embodiments, the device is a server device (e.g., a message server) that receives message delivery requests from sending terminal devices and delivers the short messages to the intended receiving terminals. In some embodiments, the device is a terminal device (e.g., a mobile telephone) associated with a number of the intended recipient of the short message.

In some embodiments, device 400, typically, includes one or more processing units (CPUs) 402, one or more network interfaces 404, memory 406, and one or more communication buses 408 for interconnecting these components (sometimes called a chipset). Client device 400 also includes a user interface 410. User interface 410 includes one or more output devices 412 that enable presentation of media content. User interface 410 also includes one or more input devices 414, including user interface components that facilitate user input such as a keyboard, keypad, a mouse, a voice-command input unit or microphone, a touch screen display, a touch-sensitive input pad, a gesture capturing camera, or other input buttons or controls. Furthermore, some client devices 400 use a microphone and voice recognition or a camera and gesture recognition to supplement or replace the keyboard. Memory 406 includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory 406, optionally, includes one or more storage devices remotely located from CPU(s) 402. Memory 406, or alternately the non-volatile memory device(s) within memory 406, includes a non-transitory computer readable storage medium. In some implementations, memory 406, or the non-transitory computer readable storage medium of memory 406, stores the following programs, modules, and data structures, or a subset or superset thereof: an operating system 416 including procedures for handling various basic system services and for performing hardware dependent tasks; a network communication module 418 for connecting user device 400 to other computers (e.g., a message server system or a terminal device) connected to one or more networks via one or more communication network interfaces 404 (wired or wireless); a presentation module 420 for enabling presentation of information (e.g., a user interface for a web page or an application program, audio and/or video content, text, etc.) at device 400 via one or more output devices 412 (e.g., displays, speakers, etc.) associated with user interface 410; an input processing module 422 for detecting one or more user inputs or interactions from one of the one or more input devices 414 and interpreting the detected input or interaction; a telephony module 424 for processing telephone call sessions between the device and other terminal devices if the device is a terminal device, and for monitoring telephone call sessions between two terminal devices if the device is a message server; and a short message processing module 426 for processing short messages in accordance with the embodiments described herein. In some embodiments, the short message processing module 426 includes message receiving module 428, message interception module 430, message revival module 432, and message delivery module 434. In some embodiments, the short message processing module also includes short message records 436, contact list 438, call log 440, etc.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 406, optionally, stores a subset of the modules and data structures identified above. Furthermore, memory 406, optionally, stores additional modules and data structures not described above.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of short message processing, comprising:
at a device having one or more processors and memory:
receiving a message delivery request for a short message from a sender of the short message;
processing the short message in accordance with a plurality of filtering rules associated an intended recipient of the short message;
in response to a determination that the short message triggers at least one of the plurality of filtering rules, intercepting delivery of the short message from the intended recipient of the short message; and
proactively re-evaluating the short message for re-delivery to the intended recipient in accordance with one or more message revival rules and one or more events occurring after the short message has been intercepted from delivery to the intended recipient.

2. The method of claim 1, wherein:
proactively re-evaluating the short message for re-delivery to the intended recipient further comprises:
after a predetermined period of time has elapsed since the interception of the short message, proactively determining whether one or more message revival events related to the short message has occurred during the predetermined period of time, wherein the one or more message revival events satisfy the one or more message revival rules; and
the method further comprises:
in accordance with a determination that at least one message revival event has occurred, delivering the short message to the intended recipient.

3. The method of claim 1, wherein:
proactively re-evaluating the short message for re-delivery to the intended recipient further comprises:
detecting a user request for creating a new contact from the intended recipient of the short message; and
in response to detecting the user request for creating the new contact, proactively determining whether the sender of the short message is the new contact being created by the intended recipient; and
the method further comprises:
in accordance with a determination that the sender of the short message is the new contact, delivering the short message to the intended recipient.

4. The method of claim 1, wherein:
proactively re-evaluating the short message for re-delivery to the intended recipient further comprises:
detecting a communication event originating from the intended recipient to the sender of the short message; and
the method further includes:
in response to detecting the communication event, delivering the short message to the intended recipient.

5. The method of claim 1, wherein proactively re-evaluating the short message for re-delivery to the intended recipient further comprises:
detecting a live communication event originating from the sender to the intended recipient of the short message, the live communication event occurring after the interception of the short message; and
in response to detecting the live communication event, proactively determining whether the live communication event satisfy at least one of the one or more message revival rules.

6. The method of claim 5, wherein proactively determining whether the live communication event satisfy at least one of the one or more message revival rules further comprises:
determining whether a duration of the live communication event exceeds a predetermined threshold duration.

7. The method of claim 6, wherein the live communication event is a telephone call from the sender to the intended recipient of the short message, and wherein delivering the short message to the intended recipient of the short message further comprises:
receiving a call termination signal from at least one of the sender and the intended recipient of the short message; and
presenting a prompt to at least the intended recipient regarding the short message before terminating the call.

8. A system for processing short messages, comprising:
one or more processors; and
memory having instructions stored thereon, the instructions, when executed by the one or more processors, cause the processors to perform operations comprising:
receiving a message delivery request for a short message from a sender of the short message;
processing the short message in accordance with a plurality of filtering rules associated an intended recipient of the short message;
in response to a determination that the short message triggers at least one of the plurality of filtering rules, intercepting delivery of the short message from the intended recipient of the short message; and
proactively re-evaluating the short message for re-delivery to the intended recipient in accordance with one or more message revival rules and one or more events occurring after the short message has been intercepted from delivery to the intended recipient.

9. The system of claim 8, wherein:
proactively re-evaluating the short message for re-delivery to the intended recipient further comprises:
after a predetermined period of time has elapsed since the interception of the short message, proactively determining whether one or more message revival events related to the short message has occurred during the predetermined period of time, wherein the one or more message revival events satisfy the one or more message revival rules; and
the operations further comprise:
in accordance with a determination that at least one message revival event has occurred, delivering the short message to the intended recipient.

10. The system of claim 8, wherein:
proactively re-evaluating the short message for re-delivery to the intended recipient further comprises:
detecting a user request for creating a new contact from the intended recipient of the short message; and
in response to detecting the user request for creating the new contact, proactively determining whether the sender of the short message is the new contact being created by the intended recipient; and
the operations further comprise:
in accordance with a determination that the sender of the short message is the new contact, delivering the short message to the intended recipient.

11. The system of claim 8, wherein:
proactively re-evaluating the short message for re-delivery to the intended recipient further comprises:
detecting a communication event originating from the intended recipient to the sender of the short message; and
the operations further include:
in response to detecting the communication event, delivering the short message to the intended recipient.

12. The system of claim 8, wherein proactively re-evaluating the short message for re-delivery to the intended recipient further comprises:
detecting a live communication event originating from the sender to the intended recipient of the short message, the live communication event occurring after the interception of the short message; and
in response to detecting the live communication event, proactively determining whether the live communication event satisfy at least one of the one or more message revival rules.

13. The system of claim 12, wherein proactively determining whether the live communication event satisfy at least one of the one or more message revival rules further comprises:
determining whether a duration of the live communication event exceeds a predetermined threshold duration.

14. The system of claim 13, wherein the live communication event is a telephone call from the sender to the intended recipient of the short message, and wherein delivering the short message to the intended recipient of the short message further comprises:
receiving a call termination signal from at least one of the sender and the intended recipient of the short message; and
presenting a prompt to at least the intended recipient regarding the short message before terminating the call.

15. A non-transitory computer-readable medium having instructions stored thereon, the instructions, when executed by one or more processors, cause the processors to perform operations comprising:
receiving a message delivery request for a short message from a sender of the short message;
processing the short message in accordance with a plurality of filtering rules associated an intended recipient of the short message;
in response to a determination that the short message triggers at least one of the plurality of filtering rules, intercepting delivery of the short message from the intended recipient of the short message; and
proactively re-evaluating the short message for re-delivery to the intended recipient in accordance with one or more message revival rules and one or more events occurring after the short message has been intercepted from delivery to the intended recipient.

16. The computer-readable medium of claim 15, wherein:
proactively re-evaluating the short message for re-delivery to the intended recipient further comprises:
after a predetermined period of time has elapsed since the interception of the short message, proactively determining whether one or more message revival events related to the short message has occurred during the predetermined period of time, wherein the one or more message revival events satisfy the one or more message revival rules; and
the operations further comprise:
in accordance with a determination that at least one message revival event has occurred, delivering the short message to the intended recipient.

17. The computer-readable medium of claim 15, wherein:
proactively re-evaluating the short message for re-delivery to the intended recipient further comprises:
detecting a user request for creating a new contact from the intended recipient of the short message; and
in response to detecting the user request for creating the new contact, proactively determining whether the sender of the short message is the new contact being created by the intended recipient; and
the operations further comprise:
in accordance with a determination that the sender of the short message is the new contact, delivering the short message to the intended recipient.

18. The computer-readable medium of claim 15, wherein:
proactively re-evaluating the short message for re-delivery to the intended recipient further comprises:
detecting a communication event originating from the intended recipient to the sender of the short message; and
the operations further include:
in response to detecting the communication event, delivering the short message to the intended recipient.

19. The computer-readable medium of claim 15, wherein proactively re-evaluating the short message for re-delivery to the intended recipient further comprises:
detecting a live communication event originating from the sender to the intended recipient of the short message, the live communication event occurring after the interception of the short message; and
in response to detecting the live communication event, proactively determining whether the live communication event satisfy at least one of the one or more message revival rules.

20. The computer-readable medium of claim 19, wherein proactively determining whether the live communication event satisfy at least one of the one or more message revival rules further comprises:
determining whether a duration of the live communication event exceeds a predetermined threshold duration.
